(19) United States
(12) Patent Application Publication
(10) Pub. No.: US 2024/0042255 A1
(43) Pub. Date: Feb. 8, 2024

(54) MULTIPURPOSE SYSTEM OF COOLING AND HEATING SUPPLY AND FIREFIGHTING SERVO-CONTROL BASED ON ENERGY-STORAGE CO2 CIRCULATION AND OPERATION METHOD OF SAME

(71) Applicants: CHINA THREE GORGES CORPORATION, Beijing (CN); CENTRAL SOUTH UNIVERSITY, Changsha city, Hunan (CN)

(72) Inventors: Xinxing LIN, Beijing (CN); Likun YIN, Beijing (CN); Lingli GU, Beijing (CN); Wen SU, Changsha city, Hunan (CN)

(73) Assignees: CHINA THREE GORGES CORPORATION, Beijing (CN); CENTRAL SOUTH UNIVERSITY, Changsha city, Hunan (CN)

(21) Appl. No.: 18/258,833

(22) PCT Filed: Sep. 29, 2021
(86) PCT No.: PCT/CN2021/121539

§ 371 Date: Jun. 22, 2023

(30) Foreign Application Priority Data
Dec. 28, 2020 (CN) 202011578241.6

(51) Int. Cl. A62C 35/60; F25B 13/00; F25B 9/00

(52) U.S. Cl. CPC A62C 35/60; F25B 13/00; F25B 9/008

(57) ABSTRACT

A multipurpose system of cooling and heating supply and firefighting servo-control based on energy-storage CO2 circulation and an operating method thereof are provided, the system based on the CO2 compression refrigeration circulation with three-stage compression and multi-stage energy storage, provides three-levels standing cool volume for the cool end, domestic hot water and heating for the hot end, and extinguishing agents CO2 for the firefighting end. By means of a new modular process design, the system realizes the independent operation and free combination of refrigeration circulation in multi-stages, so as to achieve the purpose of adjustable working conditions, flexible output and high efficiency of energy utilization. The multi-stage energy storage of liquid CO2 can realize the “flexibility” of system power consumption, and acts as a standing safety module for firefighting to be put into the safe operation of the energy system.

### FIELD

The present invention pertains to the technical field of refrigeration and relates to a multipurpose energy supply system based on energy storage CO₂ refrigeration circulation, in particular to a 3-level standing cooling and domestic hot water and heating supply and firefighting servo system composed of a CO₂ compression refrigeration circulation based on three-stage compression and multi-stage energy storage and an operation method thereof.

### BACKGROUND

Compression refrigeration circulation is the most proven and widely-used refrigeration technology, prevailing in various social production and life sectors. At present, the organic working medium used in high-efficiency refrigeration units has ozone destruction potential (ODP) and global warming potential (GWP) to a certain extent, according to the Montreal Protocol, a large number of traditional organic working media will be restricted, but there is currently a lack of high-efficiency alternative working media to choose from, so the development of natural working media has once again attracted the attention of the industry in the face of huge market demands.

Among many natural working media, CO₂ has features of non-toxicity, non-destructiveness to the ozone layer, non-flammability, non-explosiveness, high density and suchlike, and has great advantages in replacement of a refrigeration working medium. However, CO₂ has a critical temperature of only 31.1° C., a critical pressure as high as 7.38 MPa, and a large throttling loss in a trans-critical circulation, which cause low system energy efficiency, which limits its popularization and application. Due to the good flow capacity of CO₂, the CO₂ refrigeration technology comes by a new development opportunity by means of an improvement to back heating technology and expansion equipment, in particular, a CO₂ green refrigeration technology is popularized and applied in the Winter Olympics, so this technology will play an increasingly important role in the technical field of refrigeration.

In addition, a CO₂ firefighting system can be widely used in suffocating firefighting conditions, and can also be applied to firefighting places with dangerous gas whose source can cut off. The CO₂ refrigeration system can be used to provide a firefighting standby for application scenarios and provide users with a safety protection, especially in an electronic product equipment room, a mechanical and electrical equipment room, an unattended intelligentized workshop and suchlike.

A patent application number (201910739370.X) has disclosed a refrigeration system and a method for achieving a firefighting function, and a combination of a CO₂ trans-critical refrigeration technology and a fire protection system for the first time. However, this system adopts a simple trans-critical circulation, and the problem such as large system throttling loss has not been solved; in addition, this system is restricted to a CO₂ infusion volume, which limits the radiation scope of firefighting, and it can only be supplied to firefighting in an air conditioning equipment room.

Moreover, the simple CO₂ trans-critical refrigeration circulation is restricted to a limited single-stage compression capacity, which makes it difficult to realize refrigeration with a large temperature difference. Therefore, in order to further popularize the CO₂ trans-critical refrigeration circulation, it is necessary to develop a new system process with adjustable working conditions, flexible output, energy saving and high efficiency.

### SUMMARY

The present invention aims to provide a multipurpose system of cooling and heating supply and firefighting servo-control based on energy-storage CO₂ circulation and an operation method thereof, the system adopts a process of three-stage compression in combination with split-flow and back heating to effectively solve the problem such as large system energy loss, adopts three-stage cooling capacity storage to achieve flexible use of electric energy and greatly enhance the flexibility of the system, and uses the CO₂ storing tank as a firefighting servo-device to add a firefighting standby to the application scenario; in addition, the system concentrates heat for winter heating and domestic hot water, so as to form a new multipurpose energy supply system that concurrently has flexibility and adjustability, energy-saving, high-efficiency and safety.

In order to achieve the above object, the present invention adopts the following technical solutions: a multipurpose system of cooling and heating supply and firefighting servo-control based on energy-storage CO₂ circulation, comprising a first-stage CO₂ compression refrigeration circulation system, a second-stage CO₂ compression refrigeration circulation system, a third-stage CO₂ compression refrigeration circulation system, an accessory cold network, an accessory hot network, an accessory firefighting network and an accessory control system, wherein the accessory cold network is a three-stage cold network including a low-temperature range, a freezing-point temperature range and a room temperature range.

The first-stage CO₂ compression refrigeration circulation system is composed of a first-stage expander, a first-stage compressor, a first-stage gas-liquid separation device, a first-stage liquid CO₂ storing tank, a first-stage liquid CO₂ working medium pump, a first-stage CO₂ evaporator, a first-stage back heater, a first-stage ejector, a condenser, a 1^{st} 3-way valve group, a 2^{nd} 3-way valve group, a 1^{st} bypass valve group, a 2^{nd} bypass valve group, a 3^{rd} bypass valve group and a 4^{th} bypass valve group;

the CO₂ circulating medium is successively compressed by the first-stage compressor, cooled by the condenser, releases heat via the first-stage back heater, dilates via the first-stage expander, and performs gas-liquid separation via the first-stage gas-liquid separation device, a gaseous CO₂ circulating medium absorbs heat via the first-stage back heater, a liquid CO₂ circulating medium is stored by the first-stage liquid CO₂ storing tank, raises pressure via the first-stage liquid CO₂ working medium pump, evaporates and absorbs heat via the first-stage CO₂ evaporator, and flows convergently at the 2^{nd} 3-way valve group, then a high-pressure gaseous CO₂ circulating medium is ejected to a low-pressure CO₂ circulating medium in the second-stage CO₂ compression refrigeration circulation system via the first-stage ejector to enter the first-stage compressor for compression, finally ends the first-stage CO₂ compression refrigeration circulation;

the 1^{st} 3-way valve group is configured to allocate and adjust the flow of the liquid CO₂ circulating medium entering the first-stage CO₂ storing tank and the second-stage CO₂ compression refrigeration circulation system;

the 1^{st} bypass valve group is connected in parallel on both sides of the first-stage gas-liquid separation device to allocate the flow entering the first-stage gas-liquid separation device and the heat-absorbing side of the first-stage back heater, the 2^{nd} bypass valve is connected in parallel at the inlet of the first-stage back heater and the inlet pipeline entering the second-stage CO₂ compression refrigeration circulation system, the 3^{rd} bypass valve group is connected in parallel at the outlet of the first-stage compressor and the low-pressure inlet side of the first-stage ejector, so as to adjust or bypass the second-stage CO₂ compression refrigeration circulation system.

The second-stage CO₂ compression refrigeration circulation system is composed of a second-stage expander, a second-stage compressor, a second-stage gas-liquid separation device, a second-stage liquid CO₂ storing tank, a second-stage liquid CO₂ working medium pump, a second-stage CO₂ evaporator, a second-stage back heater, a second-stage ejector, a 3^{rd} 3-way valve group, a 4^{th} 3-way valve group, a 5^{th} bypass valve group, a 6^{th} bypass valve group, a 7^{th} bypass valve group and 8^{th} bypass valve group;

the CO₂ circulating medium is successively compressed by the second-stage compressor, and ejected to the first-stage CO₂ compression refrigeration circulation system by a first-stage ejector, then the CO₂ entering the second-stage CO₂ compression refrigeration circulation system is separated to release heat via the second-stage back heater, dilates via the second-stage expander, and performs gas-liquid separation via the second-stage gas-liquid separation device, a gaseous CO₂ circulating medium absorbs heat via the second-stage back heater, a liquid CO₂ circulating medium is stored by the second-stage liquid CO₂ storing tank, raises pressure via the second-stage liquid CO₂ working medium pump, evaporates and absorbs heat via the second-stage CO₂ evaporator, and flows convergently at the 4^{th} 3-way valve group, then a high-pressure gaseous CO₂ circulating medium is ejected to a low-pressure CO₂ circulating medium in the third-stage CO₂ compression refrigeration circulation system via the second-stage ejector to enter the second-stage compressor for compression, finally ends the second-stage CO₂ compression refrigeration circulation;

the 3^{rd} 3-way valve group is configured to allocate and adjust the flow of the liquid CO₂ circulating medium entering the second-stage CO₂ storing tank and the third-stage CO₂ compression refrigeration circulation system; the 5^{th} bypass valve group is connected in parallel on both sides of the second-stage gas-liquid separation device to allocate the flow entering the second-stage gas-liquid separation device and the heat-absorbing side of the second-stage back heater, the 6^{th} bypass valve is connected in parallel to the both ends of the heat-releasing side of the second-stage back heater, the 7^{th} bypass valve is connected in parallel at the outlet of the second-stage compressor and the inlet of the low-pressure side of the second-stage ejector, so as to adjust or bypass the second-stage CO₂ compression refrigeration circulation system in combination with the 3^{rd} 3-way valve.

The third-stage CO₂ compression refrigeration circulation system is composed of a third-stage expander, a third-stage compressor, a third-stage gas-liquid separation device, a third-stage liquid CO₂ storing tank, a third-stage liquid CO₂ working medium pump, a third-stage CO₂ evaporator, a third-stage back heater, a 5^{th} 3-way valve group, a 9^{th} bypass valve group, a 10^{th} bypass valve group and a 11^{th} bypass valve group;

the CO₂ circulating medium is successively compressed by the third-stage compressor, and ejected to the second-stage CO₂ compression refrigeration circulation system by a second-stage ejector, then the CO₂ entering the third-stage CO₂ compression refrigeration circulation system is separated to release heat via the third-stage back heater, dilates via the third-stage expander, and performs gas-liquid separation via the third-stage gas-liquid separation device, a gaseous CO₂ circulating medium absorbs heat via the third-stage back heater, a liquid CO₂ circulating medium is stored by the third-stage liquid CO₂ storing tank, raises pressure via the third-stage liquid CO₂ working medium pump, evaporates and absorbs heat via the third-stage CO₂ evaporator, and flows convergently at the 5^{th} 3-way valve group, then enters the third-stage compressor for compression, finally ends the third-stage CO₂ compression refrigeration circulation;

the 9^{th} bypass valve group is connected in parallel on both sides of the third-stage gas-liquid separation device to allocate the flow entering the third-stage gas-liquid separation device and the heat-absorbing side of the third-stage back heater, the 10^{th} bypass valve is connected in parallel to the both ends of the heat-releasing side of the third-stage back heater.

The accessory cold network is divided into a first-stage cold network, a second-stage cold network and a third-stage cold network, the first-stage cold network is configured to provide cool volume for the room temperature range, and consists of the first-stage CO₂ compression refrigeration circulation system, a first-stage CO₂ evaporator, a second air cooler and a 12^{th} bypass valve group; the second-stage cold network is configured to provide cool volume for the freezing-point temperature range, and consists of the second-stage CO₂ compression refrigeration circulation system and a second-stage CO₂ evaporator, the third-stage cold network is configured to provide cool volume for the low-temperature range, and consists of the third-stage CO₂ compression refrigeration circulation system and a third-stage CO₂ evaporator.

The accessory hot network is composed of a cooler, a heat-storing tank, a first air cooler and a 13^{th} bypass valve group;

the heat-storing tank is configured to enable heat production and heat supply to match with each other, and when loads have insufficient heat absorption capacity, the first air cooler is configured to discharge heat to environment, and bypassed by the 13^{th} bypass valve group.

The accessory firefighting network is composed of a 4^{th} bypass valve group, a 8^{th} bypass valve group, a 11^{th} bypass valve group, a first-stage liquid CO₂ storing tank, a second-stage liquid CO₂ storing tank, a third-stage liquid CO₂ storing tank, a CO₂ vaporization device, and a main body and a terminal end of firefighting servo control;

the liquid CO₂ in the first-stage liquid CO₂ storing tank of the first-stage CO₂ compression refrigeration circulation system, the second-stage liquid CO₂ storing tank of the second-stage CO₂ compression refrigeration circulation system, and the third-stage liquid CO₂ storing tank of the third-stage CO₂ compression refrigeration circulation system is led to the accessory firefighting network via the 4^{th} bypass valve, the 8^{th} bypass valve and the 11^{th} bypass valve, used to perform suffocating firefighting on fire sites such as occurrence of electrical sparks, unattended machine rooms, and gas sources that can be cut off; the CO₂ vaporization device is arranged before the terminal end of the firefighting network, and its interior is electrically heated, and the liquid CO₂ is used in an order of precedence of the first-stage, the second-stage, and third-stage.

The accessory control system consists of a controller and a corresponding actuator, the actuator includes a 1^{st} bypass valve group, a 2^{nd} bypass valve group, a 3^{rd} bypass valve group, a 4^{th} bypass valve group, a 5^{th} bypass valve group, a 6^{th} bypass valve group, a 8^{th} bypass valve group, a 9^{th} bypass valve group, a 11^{th} bypass valve group, a 1^{st} 3-way valve group, a 3^{rd} 3-way valve group, a 4^{th} 3-way valve group, a 5^{th} 3-way valve group, a variable frequency motor and a transmission matched with a first-stage expander, a variable frequency motor and a transmission matched with a second-stage expander, a variable frequency motor and a transmission matched with a third-stage expander, a variable frequency motor matched with a first-stage compressor, a variable frequency motor matched with a second-stage compressor and a variable frequency motor matched with a third-stage compressor.

CO₂ is used as a refrigerant of the CO₂ compression refrigeration circulation system in each stage and stored in liquid form in multi-stages; CO₂ or aqueous solution of ethylene glycol is used as a cool-carrying medium of the accessory cool network.

An operating method of the multipurpose system of cooling and heating supply and firefighting servo-control based on energy-storage CO₂ circulation, comprising the following 3 operating modes formed by controlling corresponding actuators to achieve various operating modes and multipurpose utilization of energy by means of the controller of the accessory control system:
Operating Mode 1 being selected by the system, when a cooling load is large in summer or when a cooling demand in the low-temperature range is high,
at this time, the first-stage CO₂, second-stage CO₂ and third-stage CO₂ compression refrigeration circulation systems are all actuated, due to frequent occurrence of cyclical loads, the first-stage CO₂, second-stage CO₂ and third-stage CO₂ compression refrigeration circulation systems preferably store liquid CO₂ to the first-stage liquid CO₂ storing tank, the second-stage liquid CO₂ storing tank, and the third-stage liquid CO₂ storing tank in a situation of a low electricity price or a low load demand at night; when it is necessary to extract cool volume, enabling the first-stage compressor, the second-stage compressor and the third-stage compressor within the first-stage CO₂, second-stage CO₂ and third-stage CO₂ compression refrigeration circulation systems to carry out frequency conversion adjustment in a range of preferable economy; when the loads are high or the electricity prices are high, extracting the liquid CO₂ stored in the first-stage liquid CO₂ storing tank, the second-stage liquid CO₂ storing tank, and the third-stage liquid CO₂ storing tank by the first-stage liquid CO₂ working medium pump, the second-stage liquid CO₂ working medium pump, and the third-stage liquid CO₂ working medium pump; wherein the circulating high-pressure CO₂ in the last stage is ejected to the circulating low-pressure CO₂ in the next stage via the first-stage ejector and the second-stage ejector, respectively; preferably storing the heat emitted from the system in the heat-storing tank via the cooler for domestic hot water or heating;
Operating Mode 2 being selected by the system by means of the controller, when the system operates in a non-full load, or when the cooling volume for two or one specific temperature range is huge;
when the cooling load in the low-temperature range is insufficient, closing the third-stage CO₂ compression refrigeration circulation system by controlling the 3^{rd} 3-way valve group and the third-stage compressor; when the cooling load in the freezing-point temperature range is insufficient, closing the cool storage and the cool output of the second-stage CO₂ compression refrigeration circulation system by controlling the 3^{rd} 3-way valve group and the 4^{th} 3-way valve group, and using other components as auxiliary equipment for the first-stage and third-stage CO₂ compression refrigeration circulation systems; when the outdoor temperature is low in winter or the cooling load in the room temperature range is insufficient, closing the cool storage or the cool output of the first-stage CO₂ compression refrigeration circulation system by controlling the 2^{nd} bypass valve group and the 3^{rd} bypass valve group, or by controlling the 1^{st} 3-way valve group and the 2^{nd} 3-way valve group; also possibly achieving a single-stage cool output by adjustment;
enabling the system to realize the preparation and output of single-stage or two-stage cool volume by means of the adjustment of the controller, in addition, enabling the system to realize the separate preparation and output of three-stage cool volume by means of the adjustment of the corresponding equipment;
similarly, preferably storing liquid CO₂ in the first-stage CO₂, second-stage CO₂ and third-stage CO₂ compression refrigeration circulation systems to the first-stage liquid CO₂ storing tank, the second-stage liquid CO₂ storing tank, and the third-stage liquid CO₂ storing tank, respectively, in a situation of a low electricity price or a low load demand at night; when it is necessary to extract cool volume, enabling the first-stage compressor, the second-stage compressor and the third-stage compressor within the first-stage CO₂, second-stage CO₂ and third-stage CO₂ compression refrigeration circulation systems to carry out frequency conversion adjustment in a range of preferable economy; when the loads are high or the electricity prices are high, extracting the liquid CO₂ stored in the first-stage liquid CO₂ storing tank, the second-stage liquid CO₂ storing tank, and the third-stage liquid CO₂ storing tank by the first-stage liquid CO₂ working medium pump, the second-stage liquid CO₂ working medium pump, and the third-stage liquid CO₂ working medium pump; wherein, the circulating high-pressure CO₂ in the last stage is ejected to the circulating low-pressure CO₂ in the next stage via the first-stage ejector and the second-stage ejector, respectively; preferably storing the heat emitted from the system in the heat-storing tank via the cooler for domestic hot water or heating; and
Operating Mode 3 being selected by the system, when risks such as a fire and a dangerous gas leakage occur;
when risks such as a fire and a dangerous gas leakage occur, especially at fire sites such as occurrence of electrical sparks, unattended machine rooms, and gas sources that can be cut off, enabling the refrigeration system to stop or not stop according to the danger level; when the fire is in an early stage, putting out the fire under active manual control by means of an arranged firefighting terminal interface; when the fire has reached a certain scale, extracting the liquid CO₂ stored in the first-stage liquid CO₂ storing tank, the second-stage liquid CO₂ storing tank and the third-stage liquid CO₂ storing tank successively via the first-stage liquid CO₂ working medium pump, the second-stage liquid CO₂ working medium pump and third-stage liquid CO₂ working medium pump, then vaporizing the liquid CO₂ by the CO₂ vaporization device, so as to keep high-pressure gas releasing to the danger cites until the risk disappears; when the fire situation is severe or the volume of stored CO₂ is insufficient, jointly activating the water firefighting system to suppress the fire situation in a full range.

The present invention has the following beneficial effects:
1. The three-stage CO₂ compression refrigeration circulation of the present invention differs from the traditional CO₂ trans-critical refrigeration circulation; this circulation enhances the circulation efficiency of the traditional temperature range by building a three-stage compression circulation, and achieves a larger tans-temperature refrigeration capacity.
2. The system according to the present invention achieves a mismatch between a load and a power supply by storing cool and heat in multi-stages, that is, “flexible load”, and increases the CO₂ operating volume of the system by storing CO₂ in a multi-stage liquid state; on the one hand, it can provide a consumption outlet for CO₂ under operation, and on the other hand, the expansion of the fire radiation scope of firefighting and protection scope for CO₂ adds a safeguard to the system.
3. In addition, the system realizes the flexible adjustment of three-stage compression and multi-stage refrigeration, decoupling the three-stage system, and can operate flexibly in the combination of multi-stages, two-stage and single-stage refrigeration.
4. This system enhances circulating heat efficiency by adopting gas-liquid splitting technology and back heating technology.
5. This system optimizes the operating parameters and can realize general utilization of compressors and expanders.

### BRIEF DESCRIPTION OF THE DRAWINGS

We will further describe the present invention in combination with the drawings and examples as follows.

FIG. 1 shows the multipurpose system of cooling and heating supply and firefighting servo-control based on energy-storage CO₂ circulation.

FIG. 2 is a schematic diagram of Operating Mode 1 of the multipurpose system of cooling and heating supply and firefighting servo-control based on energy-storage CO₂ circulation.

FIG. 3 is a schematic diagram of the second-stage and third-stage refrigeration in Operating Mode 2 of the multipurpose system of cooling and heating supply and firefighting servo-control based on energy-storage CO₂ circulation.

FIG. 4 is a schematic diagram of the first-stage and third-stage refrigeration in Operating Mode 2 of the multipurpose system of cooling and heating supply and firefighting servo-control based on energy-storage CO₂ circulation.

FIG. 5 is a schematic diagram of the first-stage and second-stage refrigeration in Operating Mode 2 of the multipurpose system of cooling and heating supply and firefighting servo-control based on energy-storage CO₂ circulation.

FIG. 6 is a schematic diagram of the third-stage refrigeration in Operating Mode 2 of the multipurpose system of cooling and heating supply and firefighting servo-control based on energy-storage CO₂ circulation.

FIG. 7 is a schematic diagram of the second-stage refrigeration in Operating Mode 2 of the multipurpose system of cooling and heating supply and firefighting servo-control based on energy-storage CO₂ circulation.

FIG. 8 is a schematic diagram of the first-stage refrigeration in Operating Mode 2 of the multipurpose system of cooling and heating supply and firefighting servo-control based on energy-storage CO₂ circulation.

FIG. 9 is a schematic diagram of Operating Mode 3 of the multipurpose system of cooling and heating supply and firefighting servo-control based on energy-storage CO₂ circulation.

Where, 1a—first-stage expander; 2a—first-stage compressor, 3a—first-stage gas-liquid separation device; 4a—first-stage liquid CO₂ storing tank; 5a—first-stage liquid CO₂ working medium pump; 6a—first-stage CO₂ evaporator, 7a—first-stage back heater, 8a—first-stage ejector, 9—condenser; 31—1^{st} 3-way valve group; 33—2^{nd} 3-way valve group; 21a—1^{st} bypass valve group; 22a—2^{nd} bypass valve group; 23a—3^{rd} bypass valve group; 24a—4^{th} bypass valve group; 1b—second-stage expander; 2b—second-stage compressor, 3b—second-stage gas-liquid separation device; 4b—second-stage liquid CO₂ storing tank; 5b—second-stage liquid CO₂ working medium pump; 6b—second-stage CO₂ evaporator; 7b—second-stage back heater; 8b—second-stage ejector; 32—3^{rd} 3-way valve group; 34—4^{th} 3-way valve group; 21b—5^{th} bypass valve group; 22b—6^{th} bypass valve group; 23b—7^{th} bypass valve group; 24b—8^{th} bypass valve group; 1c—third-stage expander; 2c—third-stage compressor; 3c—third-stage gas-liquid separation device; 4c—third-stage liquid CO₂ storing tank; 5c—third-stage liquid CO₂ working medium pump; 6c—third-stage CO₂ evaporator, 7c—third-stage back heater; 35—5^{th} 3-way valve group; 21c—9^{th} bypass valve group; 22c—10^{th} bypass valve group; 24c—11^{th} bypass valve group.

### DETAILED DESCRIPTION

We will further describe the embodiments of the present invention in combination with the drawings as follows.

### Example 1

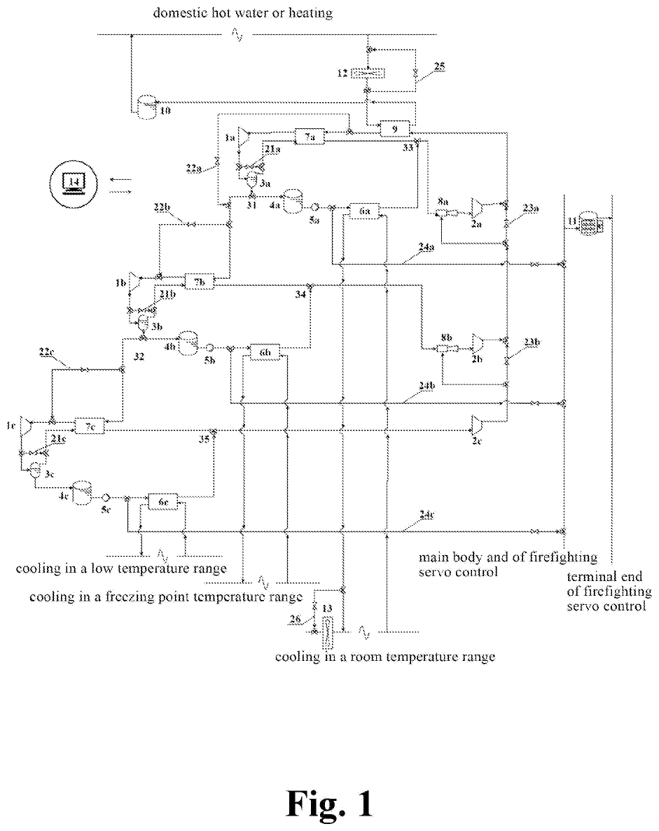

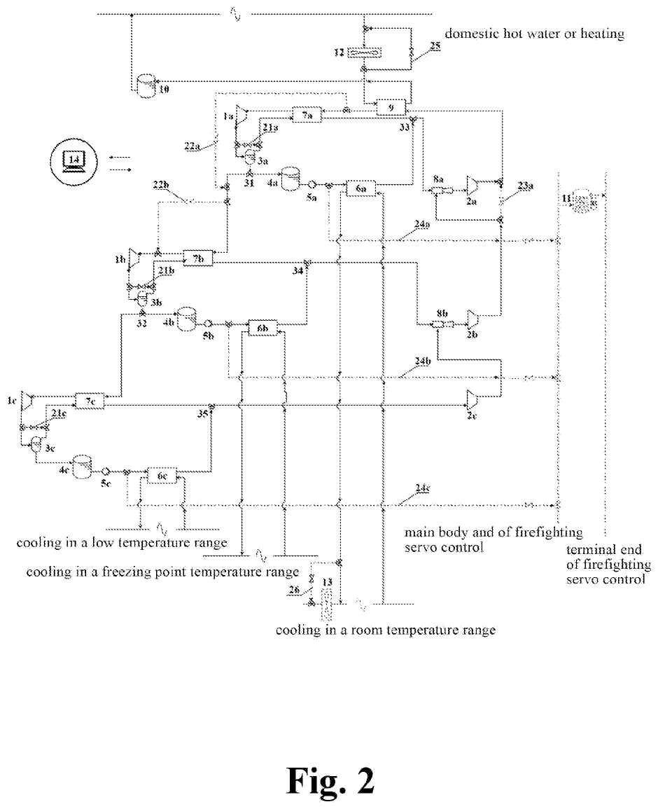

As shown in FIGS. 1-9, a multipurpose system of cooling and heating supply and firefighting servo-control based on energy-storage CO₂ circulation, comprising a first-stage CO₂ compression refrigeration circulation system, a second-stage CO₂ compression refrigeration circulation system, a third-stage CO₂ compression refrigeration circulation system, an accessory cold network, an accessory hot network, an accessory firefighting network and an accessory control system, wherein the accessory cold network is a three-stage cold network including a low-temperature range, a freezing-point temperature range and a room temperature range.

Further, the first-stage CO₂ compression refrigeration circulation system is composed of a first-stage expander 1a, a first-stage compressor 2a, a first-stage gas-liquid separation device 3a, a first-stage liquid CO₂ storing tank 4a, a first-stage liquid CO₂ working medium pump 5a, a first-stage CO₂ evaporator 6a, a first-stage back heater 7a, a first-stage ejector 8a, a condenser 9, a 1^{st} 3-way valve group 31, a 2^{nd} 3-way valve group 33, a 1^{st} bypass valve group 21a, a 2^{nd} bypass valve group 22a, a 3^{rd} bypass valve group 23a and a 4^{th} bypass valve group 24a; the CO₂ circulating medium is successively compressed by the first-stage compressor 2a, cooled by the condenser 9, releases heat via the first-stage back heater 7a, dilates via the first-stage expander 1a, and performs gas-liquid separation via the first-stage gas-liquid separation device 3a, a gaseous CO₂ circulating medium absorbs heat via the first-stage back heater 7a, a liquid CO₂ circulating medium is stored by the first-stage liquid CO₂ storing tank 4a, raises pressure via the first-stage liquid CO₂ working medium pump 5a, evaporates and absorbs heat via the first-stage CO₂ evaporator 6a, and flows convergently at the 2^{nd} 3-way valve group 33, then a high-pressure gaseous CO₂ circulating medium is ejected to a low-pressure CO₂ circulating medium in the second-stage CO₂ compression refrigeration circulation system via the first-stage ejector 8a to enter the first-stage compressor 2a for compression, finally ends the first-stage CO₂ compression refrigeration circulation;

Further, the 1^{st} 3-way valve group 31 is configured to allocate and adjust the flow of the liquid CO₂ circulating medium entering the first-stage CO₂ storing tank 4a and the second-stage CO₂ compression refrigeration circulation system;

Further, the 1^{st} bypass valve group 21a is connected in parallel on both sides of the first-stage gas-liquid separation device 3a to allocate the flow entering the first-stage gas-liquid separation device 3a and the heat-absorbing side of the first-stage back heater 7a; the 2^{nd} bypass valve 22a is connected in parallel at the inlet of the first-stage back heater 7a and the inlet pipeline entering the second-stage CO₂ compression refrigeration circulation system, the 3^{rd} bypass valve group 23a is connected in parallel at the outlet of the first-stage compressor 2a and the low-pressure inlet side of the first-stage ejector 8a, so as to adjust or bypass the second-stage CO₂ compression refrigeration circulation system.

Further, the second-stage CO₂ compression refrigeration circulation system is composed of a second-stage expander 1b, a second-stage compressor 2b, a second-stage gas-liquid separation device 3b, a second-stage liquid CO₂ storing tank 4b, a second-stage liquid CO₂ working medium pump 5b, a second-stage CO₂ evaporator 6b, a second-stage back heater 7b, a second-stage ejector 8b, a 3^{rd} 3-way valve group 32, a 4^{th} 3-way valve group 34, a 5^{th} bypass valve group 21b, a 6^{th} bypass valve group 22b, a 7^{th} bypass valve group 23b and 8^{th} bypass valve group 24b; the CO₂ circulating medium is successively compressed by the second-stage compressor 2b, and ejected to the first-stage CO₂ compression refrigeration circulation system by a first-stage ejector 8a, then the CO₂ entering the second-stage CO₂ compression refrigeration circulation system is separated to release heat via the second-stage back heater 7b, dilates via the second-stage expander 1b, and performs gas-liquid separation via the second-stage gas-liquid separation device 3b, a gaseous CO₂ circulating medium absorbs heat via the second-stage back heater 7b, a liquid CO₂ circulating medium is stored by the second-stage liquid CO₂ storing tank 4b, raises pressure via the second-stage liquid CO₂ working medium pump 5b, evaporates and absorbs heat via the second-stage CO₂ evaporator 6b, and flows convergently at the 4^{th} 3-way valve group 34, then a high-pressure gaseous CO₂ circulating medium is ejected to a low-pressure CO₂ circulating medium in the third-stage CO₂ compression refrigeration circulation system via the second-stage ejector 8b to enter the second-stage compressor 2b for compression, finally ends the second-stage CO₂ compression refrigeration circulation;

Further, the 3^{rd} 3-way valve group 32 is configured to allocate and adjust the flow of the liquid CO₂ circulating medium entering the second-stage CO₂ storing tank 4b and the third-stage CO₂ compression refrigeration circulation system; the 5^{th} bypass valve group 21b is connected in parallel on both sides of the second-stage gas-liquid separation device 3b to allocate the flow entering the second-stage gas-liquid separation device 3b and the heat-absorbing side of the second-stage back heater 7b, the 6^{th} bypass valve 22b is connected in parallel to the both ends of the heat-releasing side of the second-stage back heater 7b, the 7^{th} bypass valve 23b is connected in parallel at the outlet of the second-stage compressor 2b and the inlet of the low-pressure side of the second-stage ejector 8b, so as to adjust or bypass the second-stage CO₂ compression refrigeration circulation system in combination with the 3^{rd} 3-way valve.

Further, the third-stage CO₂ compression refrigeration circulation system is composed of a third-stage expander 1c, a third-stage compressor 2c, a third-stage gas-liquid separation device 3c, a third-stage liquid CO₂ storing tank 4c, a third-stage liquid CO₂ working medium pump 5c, a third-stage CO₂ evaporator 6c, a third-stage back heater 7c, a 5^{th} 3-way valve group 35, a 9^{th} bypass valve group 21c, a 10^{th} bypass valve group 22c and a 11^{th} bypass valve group 24c; the CO₂ circulating medium is successively compressed by the third-stage compressor 2c, and ejected to the second-stage CO₂ compression refrigeration circulation system by a second-stage ejector 8b, then the CO₂ entering the third-stage CO₂ compression refrigeration circulation system is separated to release heat via the third-stage back heater 7c, dilates via the third-stage expander 1c, and performs gas-liquid separation via the third-stage gas-liquid separation device 3c, a gaseous CO₂ circulating medium absorbs heat via the third-stage back heater 7c, a liquid CO₂ circulating medium is stored by the third-stage liquid CO₂ storing tank 4c, raises pressure via the third-stage liquid CO₂ working medium pump 5c, evaporates and absorbs heat via the third-stage CO₂ evaporator 6c, and flows convergently at the 5^{th} 3-way valve group 35, then enters the third-stage compressor 2c for compression, finally ends the third-stage CO₂ compression refrigeration circulation;

Further, the 9^{th} bypass valve group 21c is connected in parallel on both sides of the third-stage gas-liquid separation device 3c to allocate the flow entering the third-stage gas-liquid separation device 3c and the heat-absorbing side of the third-stage back heater 7c, the 10^{th} bypass valve 22c is connected in parallel to the both ends of the heat-releasing side of the third-stage back heater 7c.

Further, the accessory cold network is divided into a first-stage cold network, a second-stage cold network and a third-stage cold network, the first-stage cold network is configured to provide cool volume for the room temperature range, and consists of the first-stage CO₂ compression refrigeration circulation system, a first-stage CO₂ evaporator 6a, a second air cooler 13 and a 12^{th} bypass valve group 26; the second-stage cold network is configured to provide cool volume for the freezing-point temperature range, and consists of the second-stage CO₂ compression refrigeration circulation system and a second-stage CO₂ evaporator 6b; the third-stage cold network is configured to provide cool volume for the low-temperature range, and consists of the third-stage CO₂ compression refrigeration circulation system and a third-stage CO₂ evaporator 6c.

Further, the accessory hot network is composed of a cooler 9, a heat-storing tank 10, a first air cooler 12 and a 13^{th} bypass valve group 25;

Further, the heat-storing tank 10 is configured to enable heat production and heat supply to match with each other, and when loads have insufficient heat absorption capacity, the first air cooler 12 is configured to discharge heat to environment, and bypassed by the 13^{th} bypass valve group 25.

Further, the accessory firefighting network is composed of a 4^{th} bypass valve group 24a, a 8^{th} bypass valve group 24b, a 11^{th} bypass valve group 24c, a first-stage liquid CO₂ storing tank 4a, a second-stage liquid CO₂ storing tank 4b, a third-stage liquid CO₂ storing tank 4c, a CO₂ vaporization device 11, and a main body and a terminal end of firefighting servo control; the liquid CO₂ in the first-stage liquid CO₂ storing tank 4a of the first-stage CO₂ compression refrigeration circulation system, the second-stage liquid CO₂ storing tank 4b of the second-stage CO₂ compression refrigeration circulation system, and the third-stage liquid CO₂ storing tank 4c of the third-stage CO₂ compression refrigeration circulation system is led to the accessory firefighting network via the 4^{th} bypass valve 24a, the 8^{th} bypass valve 24b and the 11^{th} bypass valve 24c, used to perform suffocating firefighting on fire sites such as occurrence of electrical sparks, unattended machine rooms, and gas sources that can be cut off; the CO₂ vaporization device 11 is arranged before the terminal end of the firefighting network, and its interior is electrically heated, and the liquid CO₂ is used in an order of precedence of the first-stage, the second-stage, and third-stage.

Further, the accessory control system consists of a controller 14 and a corresponding actuator, the actuator includes a 1^{st} bypass valve group 21a, a 2^{nd} bypass valve group 22a, a 3^{rd} bypass valve group 23a, a 4^{th} bypass valve group 24a, a 5^{th} bypass valve group 21b, a 6^{th} bypass valve group 22b, a 8^{th} bypass valve group 24b, a 9^{th} bypass valve group 21c, a 11^{th} bypass valve group 24c, a 1^{st} 3-way valve group 31, a 3^{rd} 3-way valve group 32, a 4^{th} 3-way valve group 34, a 5^{th} 3-way valve group 35, a variable frequency motor and a transmission matched with a first-stage expander 1a, a variable frequency motor and a transmission matched with a second-stage expander 1b, a variable frequency motor and a transmission matched with a third-stage expander 1c, a variable frequency motor matched with a first-stage compressor 2a, a variable frequency motor matched with a second-stage compressor 2b and a variable frequency motor matched with a third-stage compressor 2c.

Further, CO₂ is used as a refrigerant of the CO₂ compression refrigeration circulation system in each stage and stored in liquid form in multi-stages; CO₂ or aqueous solution of ethylene glycol is used as a cool-carrying medium of the accessory cool network.

### Example 2

The operation method of the multipurpose system of cooling and heating supply and firefighting servo-control based on energy-storage CO₂ circulation, controls corresponding actuators to achieve various operating modes and multipurpose utilization of energy by means of the controller 14 of the accessory control system, and forms 3 operating modes as follows.

When a cooling load is large in summer or when a cooling demand in a low-temperature range is high, the system operates in Operating Mode 1.

At this time, the first-stage CO₂, second-stage CO₂ and third-stage CO₂ compression refrigeration circulation systems are all actuated, due to frequent occurrence of cyclical loads, the first-stage CO₂, second-stage CO₂ and third-stage CO₂ compression refrigeration circulation systems preferably store liquid CO₂ to the first-stage liquid CO₂ storing tank 4a, the second-stage liquid CO₂ storing tank 4b, and the third-stage liquid CO₂ storing tank 4c in a situation of a low electricity price or a low load demand at night; when it is necessary to extract cool volume, the first-stage compressor 2a, the second-stage compressor 2b and the third-stage compressor 2c within the first-stage CO₂, second-stage CO₂ and third-stage CO₂ compression refrigeration circulation systems carry out frequency conversion adjustment in a range of preferable economy; when the loads are low or high, the liquid CO₂ stored in the first-stage liquid CO₂ storing tank 4a, the second-stage liquid CO₂ storing tank 4b, and the third-stage liquid CO₂ storing tank 4c is extracted by the first-stage liquid CO₂ working medium pump 5a, the second-stage liquid CO₂ working medium pump 5b, and the third-stage liquid CO₂ working medium pump 5c; among them, the circulating high-pressure CO₂ in the last stage is ejected to the circulating low-pressure CO₂ in the next stage via the first-stage ejector 8a and the second-stage ejector 8b, respectively, the heat emitted from the system is preferably stored in the heat-storing tank 10 via the cooler 9 for domestic hot water or heating.

### Example 3

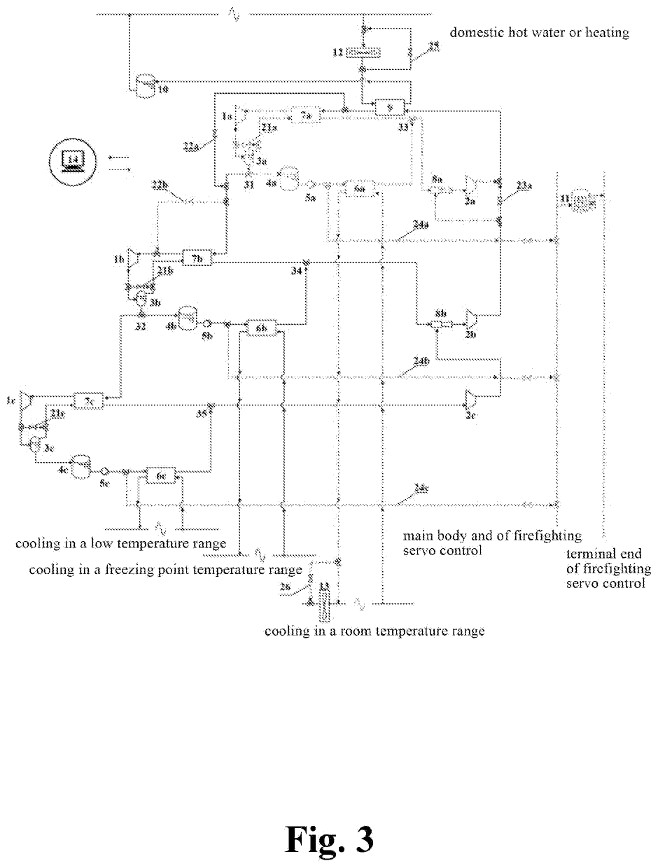

As shown in FIGS. 3-8, when the system operates in a non-full load, or when the cooling volume for two or one specific temperature range is huge, the system operates in a partial load as Operating Mode 2.

When the cooling load in the low-temperature range is insufficient, referring to FIG. 3, the third-stage CO₂ compression refrigeration circulation system is closed by controlling the 3^{rd} 3-way valve group 32 and the third-stage compressor 2c.

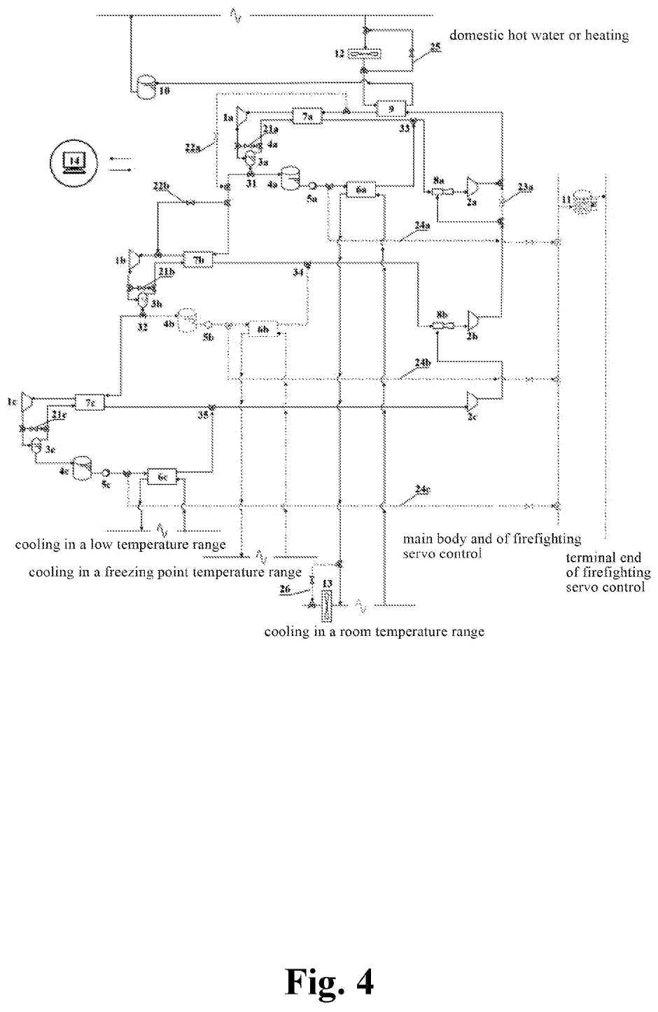

When the cooling load in the freezing-point temperature range is insufficient, referring to FIG. 4, the cool storage and the cool output of the second-stage CO₂ compression refrigeration circulation system stop by controlling the 3^{rd} 3-way valve group 32 and the 4^{th} 3-way valve group 34, and other components are used as auxiliary equipment for the first-stage and third-stage CO₂ compression refrigeration circulation systems.

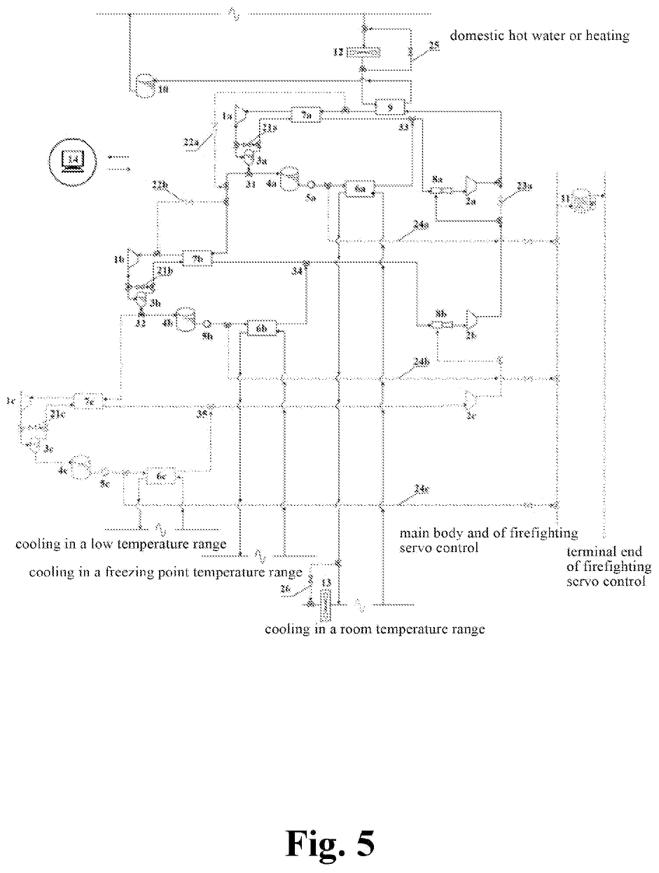

When the outdoor temperature is low in winter or the cooling load in the room temperature range is insufficient, referring to FIG. 5, the cool storage or the cool output of the first-stage CO₂ compression refrigeration circulation system stops by controlling the 2^{nd} bypass valve group 22a and the 3^{rd} bypass valve group 23a, or by controlling the 1^{st} 3-way valve group 31 and the 2^{nd} 3-way valve group 33.

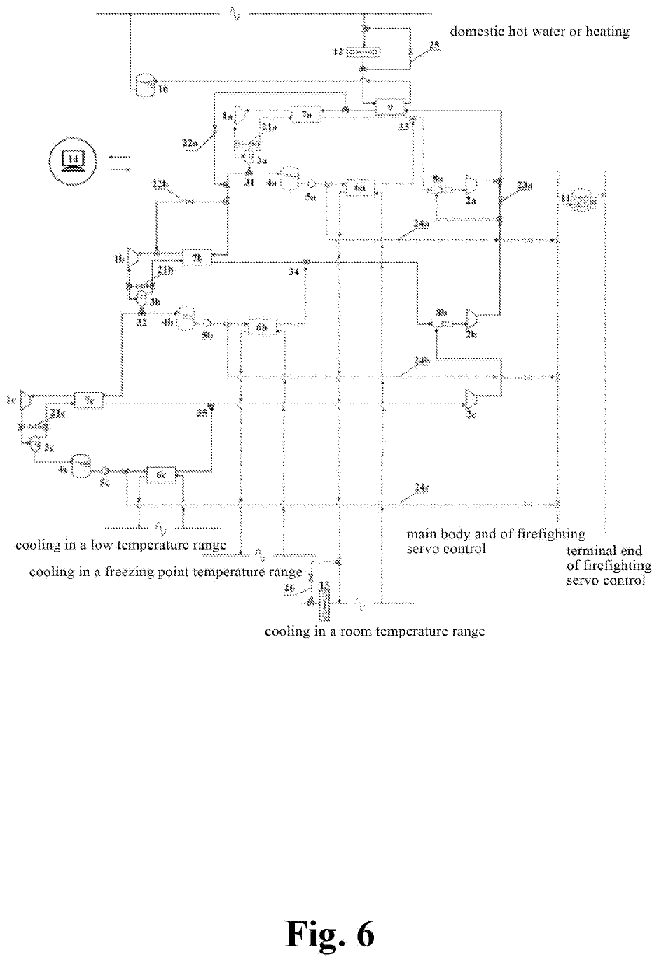

When the cool volume of the low-temperature range is preferably provided or prepared, referring to FIG. 6, the cool storage and the cool output of the second-stage CO₂ compression refrigeration circulation system stop by controlling the 3^{rd} 3-way valve group 32 and the 4^{th} 3-way valve group 34, the cool storage of the first-stage CO₂ compression refrigeration circulation system or the cool storage and the cool output of the first-stage CO₂ compression refrigeration circulation system stop by controlling the 2^{nd} bypass valve group 22a and the 3^{rd} bypass valve group 23a, or by controlling the 1^{st} 3-way valve group 31 and the 2^{nd} 3-way valve group 33.

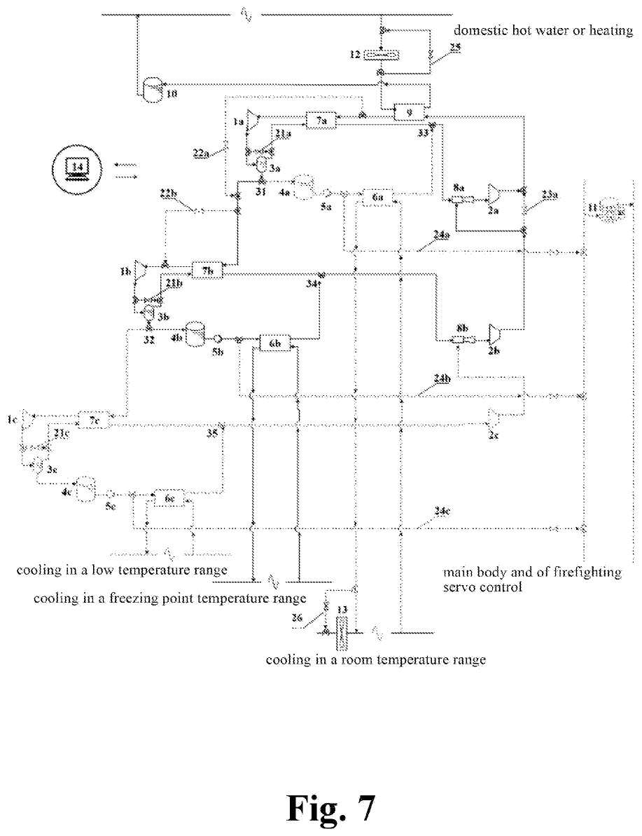

When the cool volume of the freezing-point temperature range is preferably provided or prepared, referring to FIG. 7, the third-stage CO₂ compression refrigeration circulation system is closed by controlling the 3^{rd} 3-way valve group 32 and the third-stage compressor 2c, the cool storage or the cool output of the first-stage CO₂ compression refrigeration circulation system stops by controlling the 2^{nd} bypass valve group 22a and the 3^{rd} bypass valve group 23a, or by controlling the 1^{st} 3-way valve group 31 and the 2^{nd} 3-way valve group 33.

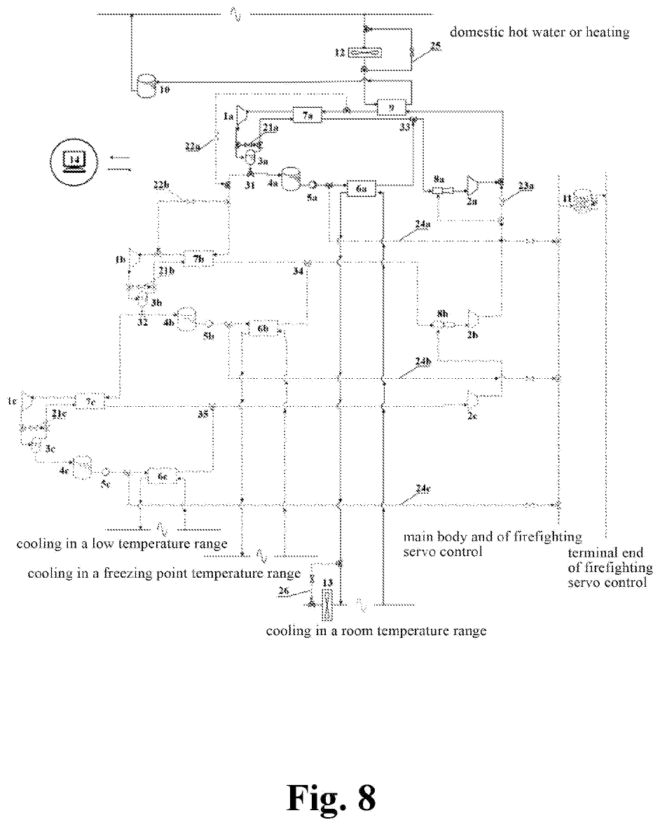

When the cool volume of the room temperature range is preferably provided or prepared, referring to FIG. 8, the cool storage and the cool output of the second-stage and third-stage CO₂ compression refrigeration circulation system stops by controlling the 1^{st} 3-way valve group 31; the first air cooler 12 and the second air cooler 13 are turned on at the right moment, when the system can realize the flexible preparation or supply of cool volume in two stages or single stage; the first-stage CO₂, second-stage CO₂ and third-stage CO₂ compression refrigeration circulation systems preferably store liquid CO₂ to the first-stage liquid CO₂ storing tank 4a, the second-stage liquid CO₂ storing tank 4b and the third-stage liquid CO₂ storing tank 4c.

The system can realize the preparation and output of cool volume at two levels by means of the adjustment of the controller 14, and the separate preparation and output of cold volume at three levels by means of the adjustment of corresponding equipment. Similarly, the first-stage CO₂, second-stage CO₂ and third-stage CO₂ compression refrigeration circulation systems preferably store liquid CO₂ to the first-stage liquid CO₂ storing tank 4a, the second-stage liquid CO₂ storing tank 4b, and the third-stage liquid CO₂ storing tank 4c in a situation of a low electricity price or a low load demand at night; when it is necessary to extract cool volume, the first-stage compressor 2a, the second-stage compressor 2b and the third-stage compressor within the first-stage CO₂, second-stage CO₂ and third-stage CO₂ compression refrigeration circulation systems 2c carry out frequency conversion adjustment in a range of preferable economy, when the loads are low or high, the liquid CO₂ stored in the first-stage liquid CO₂ storing tank 4a, the second-stage liquid CO₂ storing tank 4b, and the third-stage liquid CO₂ storing tank 4c is extracted by the first-stage liquid CO₂ working medium pump 5a, the second-stage liquid CO₂ working medium pump 5b, and the third-stage liquid CO₂ working medium pump 5c; among them, the circulating high-pressure CO₂ in the last stage is ejected to the circulating low-pressure CO₂ in the next stage via the first-stage ejector 8a and the second-stage ejector 8b, respectively; the heat emitted from the system is preferably stored in the heat-storing tank 10 via the cooler 9 for domestic hot water or heating.

### Example 4

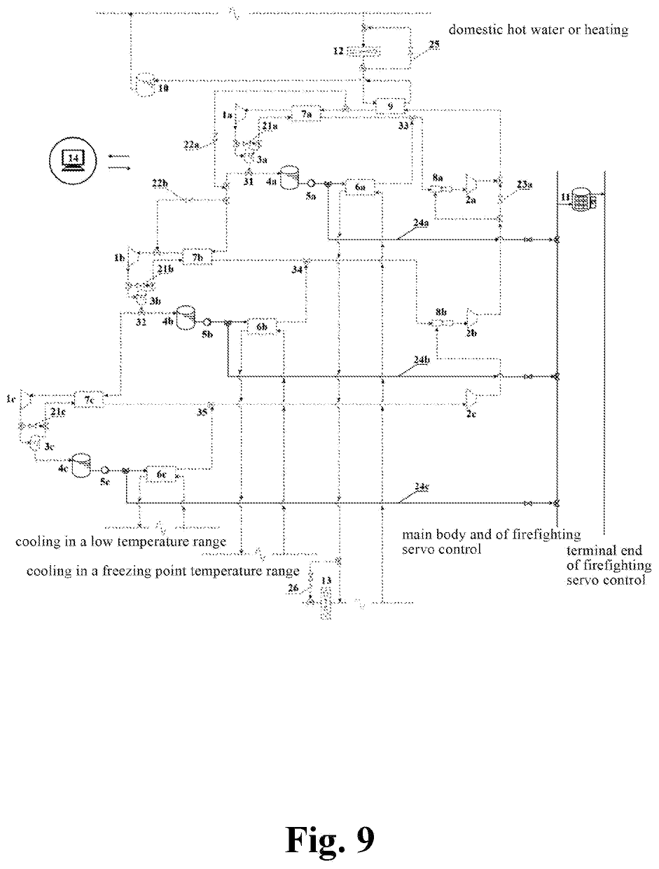

As shown in FIG. 9, when risks such as a fire and a dangerous gas leakage occur, the system operates in Operating Mode 3.

When risks such as a fire and a dangerous gas leakage occur, especially at the fire site such as occurrence of electrical sparks, unattended machine rooms, and gas sources that can be cut off, the refrigeration system can stop or not stop according to the danger level; when the fire is in an early stage, the fire can be put out under active manual control by means of an arranged firefighting terminal interface; when the fire has reached a certain scale, the liquid CO₂ stored in the first-stage liquid CO₂ storing tank 4a, the second-stage liquid CO₂ storing tank 4b and the third-stage liquid CO₂ storing tank 4c can be extracted successively via the first-stage liquid CO₂ working medium pump 5a, the second-stage liquid CO₂ working medium pump 5b and third-stage liquid CO₂ working medium pump 5c, then vaporized by the CO₂ vaporization device 11, so as to keep high-pressure gas releasing to the danger cites until the risk disappears; when the fire situation is severe or the volume of stored CO₂ is insufficient, the water firefighting system is jointly activated to suppress the fire situation in a full range.

What is claimed is:

1. A multipurpose system of cooling and heating supply and firefighting servo-control based on energy-storage CO₂ circulation, comprising a first-stage CO₂ compression refrigeration circulation system, a second-stage CO₂ compression refrigeration circulation system, a third-stage CO₂ compression refrigeration circulation system, an accessory cold network, an accessory hot network, an accessory firefighting network and an accessory control system, wherein said accessory cold network is a three-stage cold network including a low-temperature range, a freezing-point temperature range and a room temperature range.

2. The multipurpose system of cooling and heating supply and firefighting servo-control based on energy-storage CO₂ circulation according to claim 1, wherein said first-stage CO₂ compression refrigeration circulation system is composed of a first-stage expander (1a), a first-stage compressor (2a), a first-stage gas-liquid separation device (3a), a first-stage liquid CO₂ storing tank (4a), a first-stage liquid CO₂ working medium pump (5a), a first-stage CO₂ evaporator (6a), a first-stage back heater (7a), a first-stage ejector (8a), a condenser (9), a 1^{st} 3-way valve group (31), a 2^{nd} 3-way valve group (33), a 1^{st} bypass valve group (21a), a 2^{nd} bypass valve group (22a), a 3^{rd} bypass valve group (23a) and a 4^{th} bypass valve group (24a);
the CO₂ circulating medium is successively compressed by the first-stage compressor (2a), cooled by the condenser (9), releases heat via the first-stage back heater (7a), dilates via the first-stage expander (1a), and performs gas-liquid separation via the first-stage gas-liquid separation device (3a), a gaseous CO₂ circulating medium absorbs heat via the first-stage back heater (7a), a liquid CO₂ circulating medium is stored by the first-stage liquid CO₂ storing tank (4a), raises pressure via the first-stage liquid CO₂ working medium pump (5a), evaporates and absorbs heat via the first-stage CO₂ evaporator (6a), and flows convergently at the 2^{nd} 3-way valve group (33), then a high-pressure gaseous CO₂ circulating medium is ejected to a low-pressure CO₂ circulating medium in said second-stage CO₂ compression refrigeration circulation system via the first-stage ejector (8a) to enter the first-stage compressor (2a) for compression, finally ends the first-stage CO₂ compression refrigeration circulation;
the 1^{st} 3-way valve group (31) is configured to allocate and adjust the flow of the liquid CO₂ circulating medium entering the first-stage CO₂ storing tank (4a) and said second-stage CO₂ compression refrigeration circulation system;
the 1^{st} bypass valve group (21a) is connected in parallel on both sides of the first-stage gas-liquid separation device (3a) to allocate the flow entering the first-stage gas-liquid separation device (3a) and the heat-absorbing side of the first-stage back heater (7a); the 2^{nd} bypass valve (22a) is connected in parallel at the inlet of the first-stage back heater (7a) and the inlet pipeline entering said second-stage CO₂ compression refrigeration circulation system, the 3^{rd} bypass valve group (23a) is connected in parallel at the outlet of the first-stage compressor (2a) and the low-pressure inlet side of the first-stage ejector (8a), so as to adjust or bypass said second-stage CO₂ compression refrigeration circulation system.

3. The multipurpose system of cooling and heating supply and firefighting servo-control based on energy-storage CO₂ circulation according to claim 1, wherein said second-stage CO₂ compression refrigeration circulation system is composed of a second-stage expander (1b), a second-stage compressor (2b), a second-stage gas-liquid separation device (3b), a second-stage liquid CO₂ storing tank (4b), a second-stage liquid CO₂ working medium pump (5b), a second-stage CO₂ evaporator (6b), a second-stage back heater (7b), a second-stage ejector (8b), a 3^{rd} 3-way valve group (32), a 4^{th} 3-way valve group (34), a 5^{th} bypass valve group (21b), a 6^{th} bypass valve group (22b), a 7^{th} bypass valve group (23b) and 8^{th} bypass valve group (24b);
the CO₂ circulating medium is successively compressed by the second-stage compressor (2b), and ejected to said first-stage CO₂ compression refrigeration circulation system by a first-stage ejector (8a), then the CO₂ entering said second-stage CO₂ compression refrigeration circulation system is separated to release heat via the second-stage back heater (7b), dilates via the second-stage expander (1b), and performs gas-liquid separation via the second-stage gas-liquid separation device (3b), a gaseous CO₂ circulating medium absorbs heat via the second-stage back heater (7b), a liquid CO₂ circulating medium is stored by the second-stage liquid CO₂ storing tank (4b), raises pressure via the second-stage liquid CO₂ working medium pump (5b), evaporates and absorbs heat via the second-stage CO₂ evaporator (6b), and flows convergently at the 4^{th} 3-way valve group (34), then a high-pressure gaseous CO₂ circulating medium is ejected to a low-pressure CO₂ circulating medium in said third-stage CO₂ compression refrigeration circulation system via the second-stage ejector (8b) to enter the second-stage compressor (2b) for compression, finally ends the second-stage CO₂ compression refrigeration circulation;
the 3^{rd} 3-way valve group (32) is configured to allocate and adjust the flow of the liquid CO₂ circulating medium entering the second-stage CO₂ storing tank (4b) and said third-stage CO₂ compression refrigeration circulation system; the 5^{th} bypass valve group (21b) is connected in parallel on both sides of the second-stage gas-liquid separation device (3b) to allocate the flow entering the second-stage gas-liquid separation device (3b) and the heat-absorbing side of the second-stage back heater (7b), the 6^{th} bypass valve (22b) is connected in parallel to the both ends of the heat-releasing side of the second-stage back heater (7b), the 7^{th} bypass valve (23b) is connected in parallel at the outlet of the second-stage compressor (2b) and the inlet of the low-pressure side of the second-stage ejector (8b), so as to adjust or bypass said second-stage CO₂ compression refrigeration circulation system in combination with the 3^{rd} 3-way valve.

4. The multipurpose system of cooling and heating supply and firefighting servo-control based on energy-storage CO₂ circulation according to claim 1, wherein said third-stage CO₂ compression refrigeration circulation system is composed of a third-stage expander (1c), a third-stage compressor (2c), a third-stage gas-liquid separation device (3c), a third-stage liquid CO₂ storing tank (4c), a third-stage liquid CO₂ working medium pump (5c), a third-stage CO₂ evaporator (6c), a third-stage back heater (7c), a 5^{th} 3-way valve group (35), a 9^{th} bypass valve group (21c), a 10^{th} bypass valve group (22c) and a 11^{th} bypass valve group (24c);
the CO₂ circulating medium is successively compressed by the third-stage compressor (2c), and ejected to said second-stage CO₂ compression refrigeration circulation system by a second-stage ejector (8b), then the CO₂ entering said third-stage CO₂ compression refrigeration circulation system is separated to release heat via the third-stage back heater (7c), dilates via the third-stage expander (1c), and performs gas-liquid separation via the third-stage gas-liquid separation device (3c), a gaseous CO₂ circulating medium absorbs heat via the third-stage back heater (7c), a liquid CO₂ circulating medium is stored by the third-stage liquid CO₂ storing tank (4c), raises pressure via the third-stage liquid CO₂ working medium pump (5c), evaporates and absorbs heat via the third-stage CO₂ evaporator (6c), and flows convergently at the 5^{th} 3-way valve group (35), then enters the third-stage compressor (2c) for compression, finally ends the third-stage CO₂ compression refrigeration circulation;
the 9^{th} bypass valve group (21c) is connected in parallel on both sides of the third-stage gas-liquid separation device (3c) to allocate the flow entering the third-stage gas-liquid separation device (3c) and the heat-absorbing side of the third-stage back heater (7c), the 10^{th} bypass valve (22c) is connected in parallel to the both ends of the heat-releasing side of the third-stage back heater (7c).

5. The multipurpose system of cooling and heating supply and firefighting servo-control based on energy-storage CO₂ circulation according to claim 1, wherein the accessory cold network is divided into a first-stage cold network, a second-stage cold network and a third-stage cold network, the first-stage cold network is configured to provide cool volume for the room temperature range, and consists of said first-stage CO₂ compression refrigeration circulation system, a first-stage CO₂ evaporator (6a), a second air cooler (13) and a 12^{th} bypass valve group (26); the second-stage cold network is configured to provide cool volume for the freezing-point temperature range, and consists of said second-stage CO₂ compression refrigeration circulation system and a second-stage CO₂ evaporator (6b); the third-stage cold network is configured to provide cool volume for the low-temperature range, and consists of said third-stage CO₂ compression refrigeration circulation system and a third-stage CO₂ evaporator (6c).

6. The multipurpose system of cooling and heating supply and firefighting servo-control based on energy-storage CO₂ circulation according to claim 1, wherein the accessory hot network is composed of a cooler (9), a heat-storing tank (10), a first air cooler (12) and a 13^{th} bypass valve group (25);
the heat-storing tank (10) is configured to enable heat production and heat supply to match with each other, and when loads have insufficient heat absorption capacity, the first air cooler (12) is configured to discharge heat to environment, and bypassed by the 13^{th} bypass valve group (25).

7. The multipurpose system of cooling and heating supply and firefighting servo-control based on energy-storage CO₂ circulation according to claim 1, wherein the accessory firefighting network is composed of a 4^{th} bypass valve group (24a), a 8^{th} bypass valve group (24b), a 11^{th} bypass valve group (24c), a first-stage liquid CO₂ storing tank (4a), a second-stage liquid CO₂ storing tank (4b), a third-stage liquid CO₂ storing tank (4c), a CO₂ vaporization device (11), and a main body and a terminal end of firefighting servo control;
the liquid CO₂ in the first-stage liquid CO₂ storing tank (4a) of said first-stage CO₂ compression refrigeration circulation system, the second-stage liquid CO₂ storing tank (4b) of said second-stage CO₂ compression refrigeration circulation system, and the third-stage liquid CO₂ storing tank (4c) of said third-stage CO₂ compression refrigeration circulation system is led to the accessory firefighting network via the 4^{th} bypass valve (24a), the 8^{th} bypass valve (24b) and the 11^{th} bypass valve (24c), used to perform suffocating firefighting on fire sites such as occurrence of electrical sparks, unattended machine rooms, and gas sources that can be cut off; the CO₂ vaporization device (11) is arranged before the terminal end of the firefighting network, and its interior is electrically heated, and the liquid CO₂ is used in an order of precedence of the first-stage, the second-stage, and third-stage.

8. The multipurpose system of cooling and heating supply and firefighting servo-control based on energy-storage CO₂ circulation according to claim 1, wherein the accessory control system consists of a controller (14) and a corresponding actuator, the actuator includes a 1^{st} bypass valve group (21a), a 2^{nd} bypass valve group (22a), a 3^{rd} bypass valve group (23a), a 4^{th} bypass valve group (24a), a 5^{th} bypass valve group (21b), a 6^{th} bypass valve group (22b), a 8^{th} bypass valve group (24b), a 9^{th} bypass valve group (21c), a 11^{th} bypass valve group (24c), a 1^{st} 3-way valve group (31), a 3^{rd} 3-way valve group (32), a 4^{th} 3-way valve group (34), a 5^{th} 3-way valve group (35), a variable frequency motor and a transmission matched with a first-stage expander (1a), a variable frequency motor and a transmission matched with a second-stage expander (1b), a variable frequency motor and a transmission matched with a third-stage expander (1c), a variable frequency motor matched with a first-stage compressor (2a), a variable frequency motor matched with a second-stage compressor (2b) and a variable frequency motor matched with a third-stage compressor (2c).

9. The multipurpose system of cooling and heating supply and firefighting servo-control based on energy-storage CO₂ circulation according to claim 1, wherein CO₂ is used as a refrigerant of the CO₂ compression refrigeration circulation system in each stage and stored in liquid form in multi-stages; CO₂ or aqueous solution of ethylene glycol is used as a cool-carrying medium of the accessory cool network.

10. An operating method of the multipurpose system of cooling and heating supply and firefighting servo-control based on energy-storage CO₂ circulation according to claim 1, comprising the following 3 operating modes formed by controlling corresponding actuators to achieve various operating modes and multipurpose utilization of energy by means of the controller (14) of the accessory control system:
Operating Mode 1 being selected by the system, when a cooling load is large in summer or when a cooling demand in the low-temperature range is high,
at this time, the first-stage CO₂, second-stage CO₂ and third-stage CO₂ compression refrigeration circulation systems are all actuated, due to frequent occurrence of cyclical loads, the first-stage CO₂, second-stage CO₂ and third-stage CO₂ compression refrigeration circulation systems preferably store liquid CO₂ to the first-stage liquid CO₂ storing tank (4a), the second-stage liquid CO₂ storing tank (4b), and the third-stage liquid CO₂ storing tank (4c) in a situation of a low electricity price or a low load demand at night; when it is necessary to extract cool volume, enabling the first-stage compressor (2a), the second-stage compressor (2b) and the third-stage compressor (2c) within the first-stage CO₂, second-stage CO₂ and third-stage CO₂ compression refrigeration circulation systems to carry out frequency conversion adjustment in a range of preferable economy; when the loads are high or the electricity prices are high, extracting the liquid CO₂ stored in the first-stage liquid CO₂ storing tank (4a), the second-stage liquid CO₂ storing tank (4b), and the third-stage liquid CO₂ storing tank (4c) by the first-stage liquid CO₂ working medium pump (5a), the second-stage liquid CO₂ working medium pump (5b), and the third-stage liquid CO₂ working medium pump (5c); wherein the circulating high-pressure CO₂ in the last stage is ejected to the circulating low-pressure CO₂ in the next stage via the first-stage ejector (8a) and the second-stage ejector (8b), respectively; preferably storing the heat emitted from the system in the heat-storing tank (10) via the cooler (9) for domestic hot water or heating,
Operating Mode 2 being selected by the system by means of the controller (14), when the system operates in a non-full load, or when the cooling volume for two or one specific temperature range is huge,
when the cooling load in the low-temperature range is insufficient, closing the third-stage CO₂ compression refrigeration circulation system by controlling the 3^{rd} 3-way valve group (32) and the third-stage compressor (2c); when the cooling load in the freezing-point temperature range is insufficient, closing the cool storage and the cool output of the second-stage CO₂ compression refrigeration circulation system by controlling the 3^{rd} 3-way valve group (32) and the 4^{th} 3-way valve group (34), and using other components as auxiliary equipment for the first-stage and third-stage CO₂ compression refrigeration circulation systems; when the outdoor temperature is low in winter or the cooling load in the room temperature range is insufficient, closing the cool storage or the cool output of the first-stage CO₂ compression refrigeration circulation system by controlling the 2^{nd} bypass valve group (22a) and the 3^{rd} bypass valve group (23a), or by controlling the 1^{st} 3-way valve group (31) and the 2^{nd} 3-way valve group (33); also possibly achieving a single-stage cool output by adjustment;
enabling the system to realize the preparation and output of single-stage or two-stage cool volume by means of the adjustment of the controller (14), in addition, enabling the system to realize the separate preparation and output of three-stage cool volume by means of the adjustment of the corresponding equipment;
similarly, preferably storing liquid CO₂ in the first-stage CO₂, second-stage CO₂ and third-stage CO₂ compression refrigeration circulation systems to the first-stage liquid CO₂ storing tank (4a), the second-stage liquid CO₂ storing tank (4b), and the third-stage liquid CO₂ storing tank (4c), respectively, in a situation of a low electricity price or a low load demand at night; when it is necessary to extract cool volume, enabling the first-stage compressor (2a), the second-stage compressor (2b) and the third-stage compressor (2c) within the first-stage CO₂, second-stage CO₂ and third-stage CO₂ compression refrigeration circulation systems to carry out frequency conversion adjustment in a range of preferable economy; when the loads are high or the electricity prices are high, extracting the liquid CO₂ stored in the first-stage liquid CO₂ storing tank (4a), the second-stage liquid CO₂ storing tank (4b), and the third-stage liquid CO₂ storing tank (4c) by the first-stage liquid CO₂ working medium pump (5a), the second-stage liquid CO₂ working medium pump (5b), and the third-stage liquid CO₂ working medium pump (5c); wherein, the circulating high-pressure CO₂ in the last stage is ejected to the circulating low-pressure CO₂ in the next stage via the first-stage ejector (8a) and the second-stage ejector (8b), respectively; preferably storing the heat emitted from the system in the heat-storing tank (10) via the cooler (9) for domestic hot water or heating; and
Operating Mode 3 being selected by the system, when risks such as a fire and a dangerous gas leakage occur,
when risks such as a fire and a dangerous gas leakage occur, especially at fire sites such as occurrence of electrical sparks, unattended machine rooms, and gas sources that can be cut off, enabling the refrigeration system to stop or not stop according to the danger level; when the fire is in an early stage, putting out the fire under active manual control by means of an arranged firefighting terminal interface; when the fire has reached a certain scale, extracting the liquid CO₂ stored in the first-stage liquid CO₂ storing tank (4a), the second-stage liquid CO₂ storing tank (4b) and the third-stage liquid CO₂ storing tank (4c) successively via the first-stage liquid CO₂ working medium pump (5a), the second-stage liquid CO₂ working medium pump (5b) and third-stage liquid CO₂ working medium pump (5c), then vaporizing the liquid CO₂ by the CO₂ vaporization device (11), so as to keep high-pressure gas releasing to the danger cites until the risk disappears; when the fire situation is severe or the volume of stored CO₂ is insufficient, jointly activating the water firefighting system to suppress the fire situation in a full range.
